(19) United States
(12) Patent Application Publication
(10) Pub. No.: US 2020/0236904 A1
(43) Pub. Date: Jul. 30, 2020

(54) Enhanced Rotary Tool Grinder System and Method

(71) Applicant: Matthew Robert Yoo, Kirkland, WA (US)

(72) Inventor: Matthew Robert Yoo, Kirkland, WA (US)

(21) Appl. No.: 16/294,925

(22) Filed: Mar. 7, 2019

Related U.S. Application Data
(60) Provisional application No. 62/799,030, filed on Jan. 30, 2019.

(51) Int. Cl. A01K 13/00

(52) U.S. Cl. CPC A01K 13/00

(57) ABSTRACT

Systems and methods are involved with but are not limited to an apparatus including a shank portion including a first longitudinal axis, the shank being shaped and sized to couple with a rotary tool; and a bit head portion including a first end, a second end, and a cylindrical grinder portion extending therebetween, the shank portion extending from the first end, the cylindrical grinder portion cylindrically shaped about a second longitudinal axis aligned in common with the first longitudinal axis, the cylindrical grinder portion including an abrasive cylindrical surface circumferentially positioned thereon, the second end including an end grinder portion, the end grinder portion including an abrasive surface positioned thereon. In addition, other aspects are described in the claims, drawings, and text forming a part of the present disclosure.

### SUMMARY

In one or more aspects, systems and methods include, but are not limited to an apparatus including a shank portion including a first longitudinal axis, the shank being shaped and sized to couple with a rotary tool; and a bit head portion including a first end, a second end, and a cylindrical grinder portion extending therebetween, the shank portion extending from the first end, the cylindrical grinder portion cylindrically shaped about a second longitudinal axis aligned in common with the first longitudinal axis, the cylindrical grinder portion including an abrasive cylindrical surface circumferentially positioned thereon, the second end including an end grinder portion, the end grinder portion including an abrasive surface positioned thereon. In addition, other aspects are described in the claims, drawings, and text forming a part of the present disclosure. In other one or more aspects, systems and methods include, but are not limited to a method including moving a dog nail in a linear back-forth motion across a cylindrical grinder portion of a rotary grinder bit as a rotary tool spins the rotary grinder bit; and moving the dog nail in an angular back-forth motion across an end grinder portion of the rotary grinder bit as the rotary tool spins the rotary grinder bit. In addition to the foregoing, other method aspects are described in the claims, drawings, and text forming a part of the disclosure set forth herein.

In addition to the foregoing, various other aspects are set forth and described in the teachings such as text (e.g., claims and/or detailed description) and/or drawings of the present disclosure. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of portable electronic device case based articles of manufacture, compositions of matter, systems for producing and/or methods for producing same that may provide context, for instance, in introducing one or more processes and/or devices described herein.

FIG. 1 is a front perspective view depicting a first embodiment of an enhanced rotary tool grinder bit head with a first embodiment of a shank.

FIG. 2 is a top plan view of the first embodiment of the enhanced rotary tool grinder bit head showing its distal end.

FIG. 3 is a side-elevational view of the first embodiment of the enhanced rotary tool grinder bit head and first embodiment of the shank of FIG. 1.

FIG. 4 is a cross-sectional side-elevational view of the first embodiment of the enhanced rotary tool grinder bit head and first embodiment of the shank of FIG. 1.

FIG. 5 is a front perspective view depicting a second embodiment of an enhanced rotary tool grinder bit head and first embodiment of the shank.

FIG. 6 is a top plan view of the second embodiment of the enhanced rotary tool grinder bit head and first embodiment of the shank of FIG. 5.

FIG. 7 is a side-elevational view of the second embodiment of the enhanced rotary tool grinder bit head and first embodiment of the shank of FIG. 6.

FIG. 8 is a side-elevational cross-sectional view of the second embodiment of the enhanced rotary tool grinder bit head and first embodiment of the shank of FIG. 1.

FIG. 9 is a side-elevational cross-sectional partial view of the first embodiment of the shank of FIGS. 1 and 5.

FIG. 10 is a side-elevational cross-sectional view of a second embodiment of a shank for embodiments of the enhanced rotary tool grinder bit heads of FIGS. 1 and 5.

FIG. 11 is a side-elevational cross-sectional view of a second embodiment of a shank for embodiments of the enhanced rotary tool grinder bit heads of FIGS. 1 and 5.

FIG. 12 is a front perspective view depicting the first embodiment of the enhanced rotary tool grinder bit head with the first embodiment of the shank of FIG. 1 coupled with a rotary tool and with the curvilinear cylindrical grinder portion of the enhanced rotary tool grinder bit head in use with the rotary tool to grind a dog nail, also known as a dog claw.

FIG. 13 is a front elevational view depicting the first embodiment of the enhanced rotary tool grinder bit head with the first embodiment of the shank of FIG. 1 coupled to a rotary tool.

FIG. 14 is a front elevational cross-sectional view taken along the 14-14 line of FIG. 14 depicting the first embodiment of the enhanced rotary tool grinder bit head with the first embodiment of the shank of FIG. 1 coupled with a rotary tool and with the curvilinear cylindrical grinder portion of the enhanced rotary tool grinder bit head in use with the rotary tool to grind a dog nail in center position.

FIG. 15 is a front elevational cross-sectional view depicting the first embodiment of the enhanced rotary tool grinder bit head with the first embodiment of the shank of FIG. 1 coupled with a rotary tool and with the curvilinear cylindrical grinder portion of the enhanced rotary tool grinder bit head in use with the rotary tool to grind a dog nail in proximal position.

FIG. 16 is a front elevational cross-sectional view depicting the first embodiment of the enhanced rotary tool grinder bit head with the first embodiment of the shank of FIG. 1 coupled with a rotary tool and with the curvilinear cylindrical grinder portion of the enhanced rotary tool grinder bit head in use with the rotary tool to grind a dog nail in distal position.

FIG. 17 is a front elevational cross-sectional view depicting the first embodiment of the enhanced rotary tool grinder bit head with the first embodiment of the shank of FIG. 1 coupled with a rotary tool and with the cuplike end grinder portion of the enhanced rotary tool grinder bit head in use with the rotary tool to grind a dog nail in zero tilt position.

FIG. 18 is a front elevational cross-sectional view depicting the first embodiment of the enhanced rotary tool grinder bit head with the first embodiment of the shank of FIG. 1 coupled with a rotary tool and with the cuplike end grinder portion of the enhanced rotary tool grinder bit head in use with the rotary tool to grind a dog nail in left tilt position.

FIG. 19 is a front elevational cross-sectional view depicting the first embodiment of the enhanced rotary tool grinder bit head with the first embodiment of the shank of FIG. 1 coupled with a rotary tool and with the cuplike end grinder portion of the enhanced rotary tool grinder bit head in use with the rotary tool to grind a dog nail in right tilt position.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Conventional rotary-tool-based dog nail grinders are useful, but lack efficiencies, convenience, and other factors that can adversely affect operational effectiveness for use by dog groomers and others.

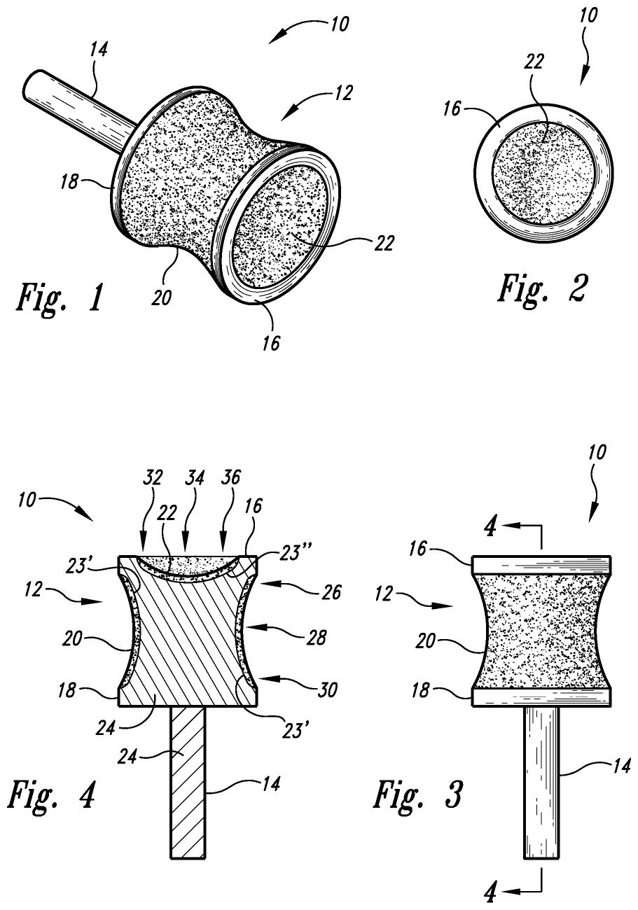

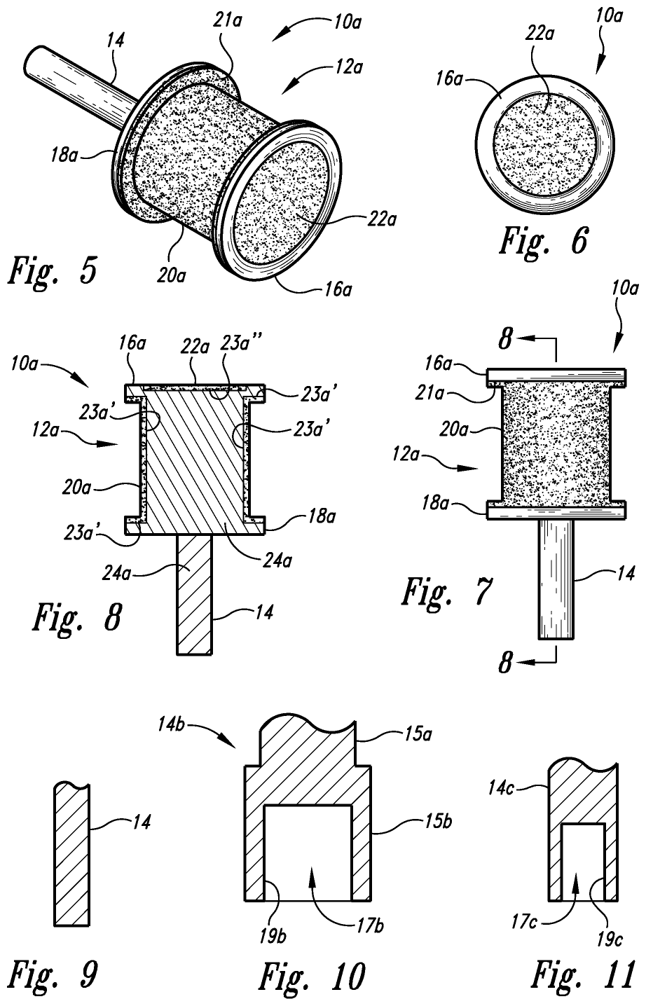

Turning to FIG. 1, a front perspective view depicts a first embodiment of an enhanced rotary tool grinder bit 10 having first embodiment bit head 12 and first embodiment shank portion 14 extending therefrom. First embodiment bit head 12 includes distal end 16, proximal end 18, with concave curvilinear cylindrical grinder portion 20 extending therebetween. Distal end 18 of first embodiment bit head 12 includes cuplike grinder portion 22 further shown in FIG. 2 in top plan view to include a cuplike, bowllike, dishlike, or other abrasive coated radially symmetrical depression.

Referring to FIG. 3, a side-elevational view of the first embodiment of rotary tool grinder bit 10 further shows an exemplary profile of concave curvilinear cylindrical grinder portion 20. Diameter of first embodiment bit head 12 at narrowest point of concave curvilinear cylindrical grinder portion 20 can be approximately 50% of diameter first embodiment bit head 12 at widest point of concave curvilinear cylindrical grinder portion 20 or can be selected from a range of diameters as further discussed below.

Further on to FIG. 4, a cross-sectional side-elevational view of the first embodiment bit head 12 and first embodiment shank portion 14 shows abrasive grit 23′ and abrasive grit 23″ affixed to bit body 24 for concave curvilinear cylindrical grinder portion 20 and concave cuplike end grinder portion 22, respectively. For illustration purposes, distal position 26, center position 28, proximal position 30, edge position 32, center position 34, and edge position 36 of the first embodiment bit head 12 have been identified. As depicted, shank portion 14 is of a rod-like shape and so fashioned along a longitudinal axis that is aligned in common with that longitudinal axis of concave curvilinear cylindrical grinder portion 20. Concave curvilinear cylindrical grinder portion 20 is depicted as having a substantially concave curvilinear surface profile in which first embodiment bit head 12 has a first diameter positioned midway between distal end 16 and proximal end 18 at center position 28. First embodiment bit head 12 has a second diameter positioned at distal end 16 (distal position 26) and also positioned at proximal end 18 (proximal position 30). As shown, first diameter is smaller than second diameter. In some embodiments selection of first diameter can range between 40% and 80% in size of second diameter. In other embodiments selection of first diameter can range between 40% and 60% in size of second diameter. Abrasive grit 23′ is shown along concave curvilinear cylindrical grinder portion 20 to form an abrasive cylindrical surface circumferentially positioned thereon. Abrasive grit 23″ is shown along cuplike end grinder portion 22 to form an abrasive surface positioned thereon with a substantially concave cuplike surface profile.

Second embodiment of rotary tool grinder bit 10a is depicted in FIGS. 5-8 as having second embodiment bit head 12a and first embodiment shank portion 14. Second embodiment bit head 12a includes distal end 16a, proximal end 18a, linear cylindrical grinder portion 20a, overhang edge 21a, flat disklike end grinder portion 22a, abrasive grit 23a′, abrasive grit 23a″, and bit body 24a. Linear cylindrical grinder portion 20a is depicted as having a substantially linear surface profile.

Construction methods for rotary tool grinder bit 10 and rotary tool grinder bit 10a can vary. For instance, for bit body 24 or bit body 24a, a solid steel metal rod that can be machined on a computerized numerical control (CNC) machine to form integrated whole piece rotary tool grinder bit 10 or rotary tool grinder bit 10a, respectively having bit body 24 of one-piece machined metal. Furthermore, some implementations can use nickel plated steel to help prevent corrosion in humid environments. For instance, once a solid steel metal rod is turned to the shape of rotary tool grinder bit 10 or rotary tool grinder bit 10a without yet having abrasive grit 23′, abrasive grit 23″, abrasive grit 23a′, or abrasive grit 23a″, natural or synthetic man-made diamonds can be bonded to the turned steel utilizing an exemplary permanent electroplating process that can be conducted in two stages. The first stage of this exemplary electroplating process involves partially masking to prevent diamond adhesion on certain portions (e.g. various uncoated portions shown in FIGS. 1-8, 12, and 14-19 that do not have abrasive grit 23′, abrasive grit 23″, abrasive grit 23a′, or abrasive grit 23a″) to prevent accidental injury to users. For instance, with the first stage, a coarser grit (such as 40 to 60 grit) can be applied as abrasive grit 23′ to the concave curvilinear cylindrical grinder portion 20 or abrasive grit 23a′ to the linear cylindrical grinder portion 20a. Once this exemplary first stage is completed, the already diamond coated portion is masked off and a finer grit, such as 100 to 150 grit size, as abrasive grit 23a′ or abrasive grit 23a″ is applied to concave cuplike end grinder portion 22 or flat disklike end grinder portion 22a, respectively. Particles of coarse and fine grit size values selected from a range of 30 to 6000 are also contemplated using Coated Abrasive Manufacturers Institute standards. Diamond grit particles utilized can be lab created but natural diamonds can also be utilized. Lab diamonds and/or metal-bonded industrial diamonds, such as nickel-plated diamonds, can be typically utilized because of their consistent and predictable pricing. Other types of abrasives may be used with composite or glue bond. Such alternative abrasives may include one or more of garnet, silicon carbide, flint, alumina-Zirconia, prefer other abrasives, for example, emery, ceramic aluminum oxide, chromium oxide, or aluminum oxide. Generally, an abrasive material with a hardness greater than the hardness found with dog nails would be suitable, but some abrasives could be more suitable depending on performance, cost, etc. Other alternatives could include casting or single-molding or dual-molding with one or more abrasive containing composite materials or other abrasive containing materials. 3D printing could also be utilized with various metal or composite materials. An abrasive surface can also be made using machined grooves in metal surfaces, or molded or 3D printed grooves in composite or other material surfaces.

Partial cross-sectional views are depicted of first embodiment shank portion 14, second embodiment shank portion 14b, and third embodiment shank portion 14c in FIGS. 9-11, respectively, which offer accommodation options for coupling various sizes of first embodiment bit head 12 and second embodiment bit head 12a to rotary tools. Second embodiment shank portion 14b is depicted as having narrow portion 15a and wide portion 15b with threaded opening 17b with threaded surface 19b and third embodiment shank portion 14c is depicted as having threaded opening 17c with threaded surface 19c to assist with accommodation in coupling second embodiment shank portion 14b and third embodiment shank portion 14c to rotary tools. Smaller embodiment sizes are useful for small dogs such as 30 pounds and under.

Second embodiment shank portion 14b and third embodiment shank portion 14c can be used for instance where rotary tool 100 may not have sufficient coupling capacity for shank portion 14. If rotary tool 100 has a removable collet (not shown), the collet can be removed so that the shaft of the rotary tool 100 can be threaded directly on to second embodiment shank portion 14b or third embodiment shank portion 14c.

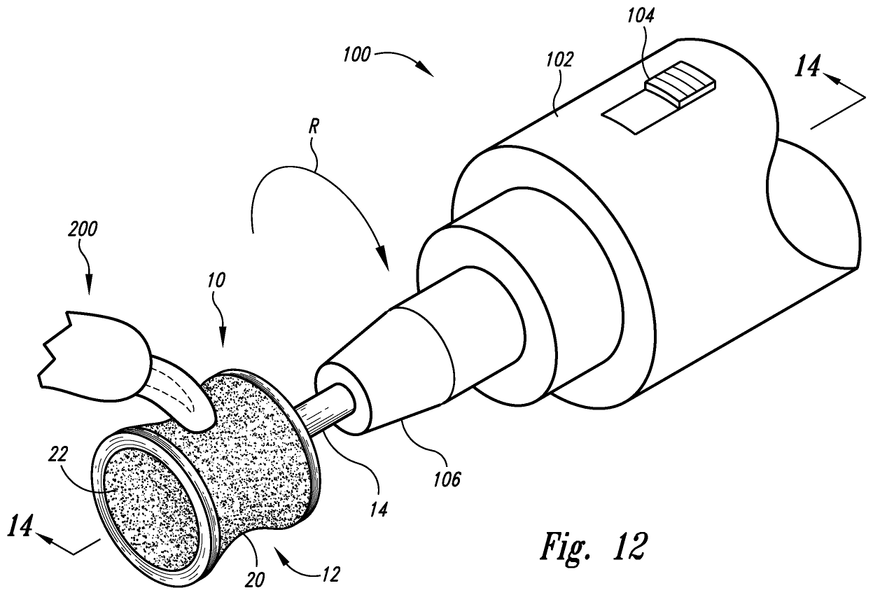

As discussed, first embodiment of rotary tool grinder bit 10 is shown in FIG. 12 depicted in perspective view as shank portion 14 being sized and shaped to couple with a chuck of rotary tool 100 to grind nail of dog paw 200, also known as a dog claw. Rotary tool 100 is envisioned and to be motorized such as a drill or other rotary tool to impart rotation motion “R” as shown to first embodiment of rotary tool grinder bit 10. FIG. 12 depicts a typical sizing implementation wherein concave curvilinear cylindrical grinder portion 20 for implementations is approximately two to three times the average width of a dog nail so a user can use a back-forth linear motion as described below. Of note, the back-forth linear motion described below allows for abrasive 23′ or 23a′ to clear out nail dust while rotary tool grinder bit 10 spins. Further shown, concave cuplike end grinder portion 22 can be typically proportionate to concave curvilinear cylindrical grinder portion 20 as shown.

As shown, rotary tool 100 is depicted as including housing 102, power switch 104, and chuck 106, which is shown coupled to first embodiment shank portion 14. Further shown in FIG. 13, rotary tool 100 is depicted as having power cord 108, but battery-powered embodiments of rotary tool 100 are also envisioned for use with first and second embodiments of enhanced rotary tool grinder bit 10 and 10a, respectively. Rotary tool 100 can include a class of rotary motive producers that at times could have been generally referred to as “Dremel—like tools” since such rotary motive producers may include particular versions that may have been associated one or more trademarks by the Dremel Company, Racine Wis.

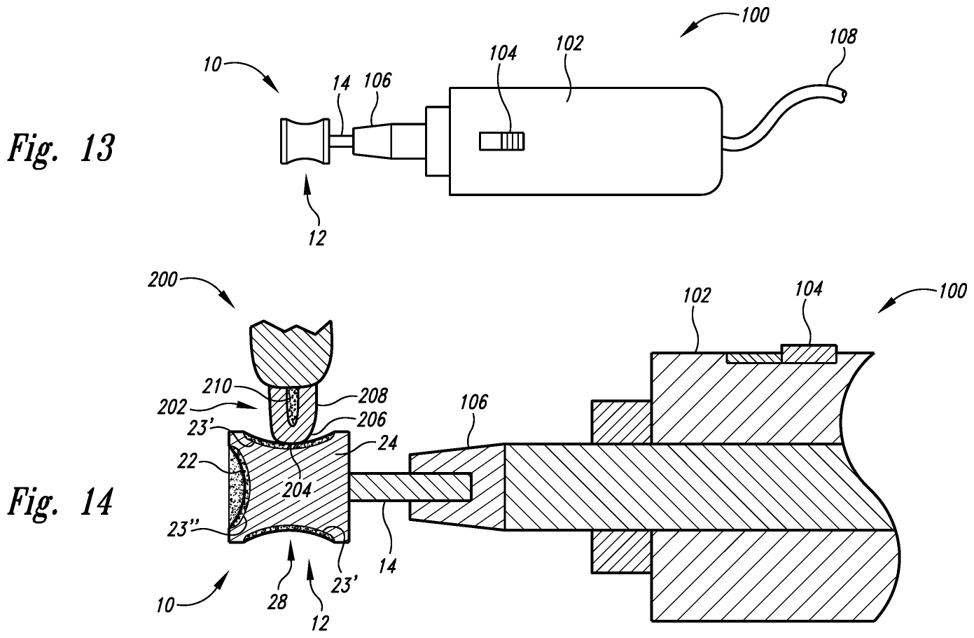

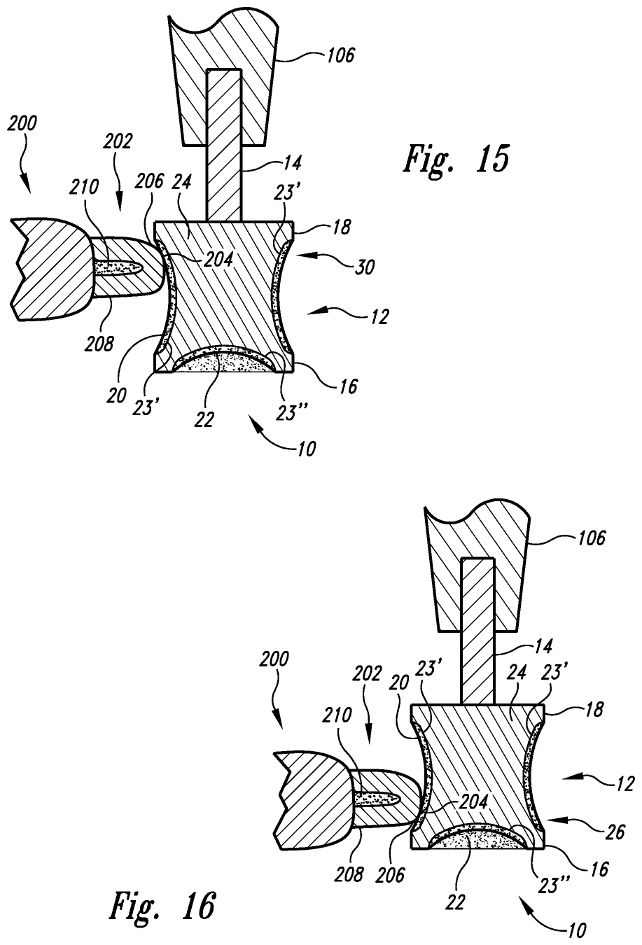

Turning to FIGS. 14-16, shown in cross-sectional views is use of concave curvilinear cylindrical grinder portion 20 of first embodiment bit head 12 to grind nail 202 of dog paw 200. Nail 202 is shown as including forward end portion 204, mid-side portion 206, rearward portion 208, and quick portion 210. In using concave curvilinear cylindrical grinder portion 20, nail 202 and/or the combination of grinder bit 10—rotary tool 100 is linearly moved back-forth from proximal position (FIG. 15) through center position (FIG. 14) to distal position (FIG. 16) back through center position (FIG. 14) to proximal position (FIG. 15) as rotary tool 100 spins in rotational direction “R” (“R” shown in FIG. 12). As shown, the longitudinal direction of quick portion 210 is kept substantially perpendicular to the longitudinal direction of first embodiment shank portion 14 through this linear back-forth motion. As a consequence, concave curvilinear cylindrical grinder portion 20 is able to substantially grind forward end portion 204 and portions of mid-side portion 206 of nail 202 with this relatively simple linear back-forth motion.

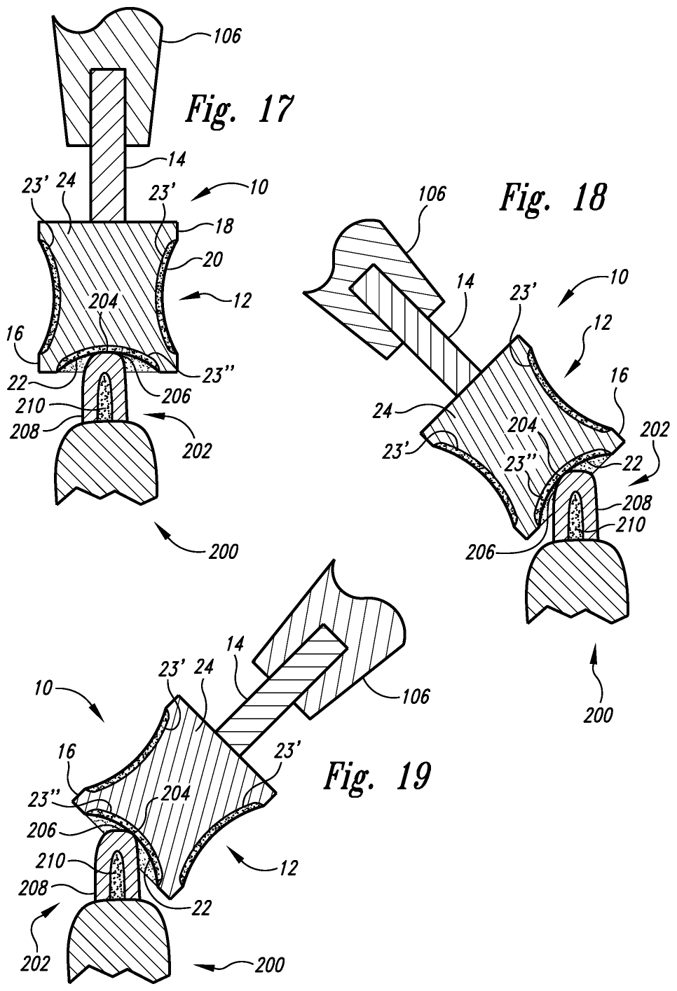

Turning to FIGS. 17-19, shown in cross-sectional views is use of cuplike end grinder portion 20 of first embodiment bit head 12 to grind nail 202 of dog paw 200. In using cuplike end grinder portion 20, nail 202 and/or the combination of grinder bit 10—rotary tool 100 is angularly moved back-forth from left-tilt position (FIG. 18) through center no-tilt position (FIG. 17) to right-tilt position (FIG. 19) back through center no-tilt position (FIG. 17) to left-tilt position (FIG. 18) as rotary tool 100 spins in rotational direction “R” (direction “R” shown in FIG. 12). As shown, nail 202 is kept substantially in contact with an area near center position of cuplike end grinder portion 20 through this angular back-forth motion. As a consequence, cuplike end grinder portion 20 is able to substantially grind forward end portion 204 and portions of mid-side portion 206 of nail 202 with this relatively simple angular back-forth motion. As a result of linear back-forth motion described with use of concave curvilinear cylindrical grinder portion 20 and angular back-forth motion described with use of concave cuplike end grinder portion 22, dog nail 202 is ground with a first fineness of grind according to size of abrasive grit 23′ to a first smoothness and then ground with a second fineness of grind size of abrasive grit 23″ smaller than size of abrasive grit 23′ to a second smoothness, respectively, whereas the second fineness of grind or polishing of dog nail 202 is smoother than the first fineness of grind or polishing of dog nail 202. Smoothness can be judged by how dog nail 202 appears along ground edges with aid with a magnifying glass or other optical magnification. For instance, under optical magnification it can be apparent that size of ridges, cuts, scraps, etc. along dog nail edge where grinding has occurred will be of smaller size and thus smoother with second fineness of grind to a second smoothness of dog nail 202 compared with the first fineness of grind to a first smoothness of dog nail 202. The second smoothness having fewer projections or less unevenness of surface than the first smoothness.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A rotary grinder bit comprising:
a shank portion including a first longitudinal axis, the shank being shaped and sized to couple with a rotary tool; and
a bit head portion including a first end, a second end, and a cylindrical grinder portion extending therebetween, the shank portion extending from the first end, the cylindrical grinder portion cylindrically shaped about a second longitudinal axis aligned in common with the first longitudinal axis, the cylindrical grinder portion including an abrasive cylindrical surface circumferentially positioned thereon, the second end including an end grinder portion, the end grinder portion including an abrasive surface positioned thereon wherein the abrasive cylindrical surface of the cylindrical grinder portion includes particles of a first grit size and the abrasive surface of the end grinder portion includes particles of a second grit size, the second grit size being smaller than the first grit size.

2. (canceled)

3. The rotary grinder bit of claim 2 wherein the first grit size is selected from a range of between 100 to 150 and the second grit size is selected from a range of 40 to 60 of the Coated Abrasive Manufacturers Institute standards.

4. The rotary grinder bit of claim 1 wherein the cylindrical grinder portion includes a substantially concave curvilinear surface profile.

5. The rotary grinder bit of claim 3 wherein cylindrical grinder portion includes a first diameter and a second diameter, the first diameter being positioned midway between the first end of the bit head portion and the second end of the bit head portion, and the second diameter positioned adjacent the first end of the bit head portion, the first diameter being selected from a range between 40% and 60% in size of the second diameter.

6. The rotary grinder bit of claim 1 wherein the cylindrical grinder portion includes a substantially linear surface profile.

7. The rotary grinder bit of claim 1 wherein the end grinder portion includes a substantially concave cuplike surface profile.

8. The rotary grinder bit of claim 6 wherein the cylindrical grinder portion includes a substantially concave curvilinear surface profile.

9. The rotary grinder bit of claim 1 wherein the end grinder portion includes a substantially flat surface profile.

10. The rotary grinder bit of claim 1 wherein the shank portion is rod-shaped sized and shaped for a chuck of a rotary tool.

11. The rotary grinder bit of claim 1 wherein the shank portion includes a threaded opening sized and shaped to be threaded on to a rotary tool.

12. The rotary grinder bit of claim 1, the shank portion and the bit head portion being a bit body of one-piece machined metal and one or more abrasive surfaces of diamond particles affixed thereto.

13. (canceled)

14. The rotary grinder bit of claim 1, the shank portion and the bit head portion being a bit body and one or more abrasive surfaces of a composite material.

15. A rotary grinder system comprising:
a rotary grinder bit including a shank portion and a bit head portion, the shank portion including a first longitudinal axis, the shank being shaped and sized to couple with a rotary tool, the bit head portion including a first end, a second end, and a cylindrical grinder portion extending therebetween, the shank portion extending from the first end, the cylindrical grinder portion cylindrically shaped about a second longitudinal axis aligned in common with the first longitudinal axis, the cylindrical grinder portion including an abrasive cylindrical surface circumferentially positioned thereon, the second end including an end grinder portion, the end grinder portion including an abrasive surface positioned thereon wherein the abrasive cylindrical surface of the cylindrical grinder portion includes particles of a first grit size and the abrasive surface of the end grinder portion includes particles of a second grit size, the second grit size being smaller than the first grit size; and
a rotary tool configured to couple with the shank of the rotary grinder bit, the rotary tool including an electric motor configured to rotate the shank of the rotary grinder bit coupled to the rotary tool.

16. The rotary grinder bit of claim 15 wherein the cylindrical grinder portion includes a substantially concave curvilinear surface profile.

17. The rotary grinder bit of claim 15 wherein the end grinder portion includes a substantially concave cuplike surface profile.

18. The rotary grinder bit of claim 17 wherein the cylindrical grinder portion includes a substantially concave curvilinear surface profile.

19-20. (canceled)
